(19) United States
(12) Patent Application Publication
(10) Pub. No.: US 2024/0325981 A1
(43) Pub. Date: Oct. 3, 2024

(54) MODULAR FLUID FILTRATION CASSETTE ASSEMBLY

(71) Applicant: Donaldson Company, Inc., Bloomington, MN (US)

(72) Inventors: Jinxiang Zhou, Greenville, SC (US); Matthew P. Goertz, Bloomington, MN (US); Veli Kalayci, Eden Prairie, MN (US); Andrew J. Dallas, Lakeville, MN (US); Raymond S. Cleveland, Minneapolis, MN (US); Daniel P. Little, Eden Prairie, MN (US); Daniel J. Dotzler, Webster, MN (US); Aflal Rahmathullah, Savage, MN (US)

(21) Appl. No.: 18/622,600

(22) Filed: Mar. 29, 2024

Related U.S. Application Data
(60) Provisional application No. 63/455,870, filed on Mar. 30, 2023.

(51) Int. Cl. B01D 63/08

(52) U.S. Cl. CPC B01D 63/0822; B01D 2313/041; B01D 2313/54

(57) ABSTRACT

The present disclosure relates to a cassette assembly. An inlet cassette plate defines an inlet cassette inlet flow path and an inlet cassette outlet flow path. An outlet cassette plate is configured to be arranged in a stack with the inlet cassette plate. The outlet cassette plate defines an outlet cassette inlet flow path configured to be laterally aligned with the inlet cassette inlet flow path, and an outlet cassette outlet flow path configured to be laterally aligned with the inlet cassette outlet flow path. An inlet plug is configured to be inserted in the outlet cassette inlet flow path. An outlet plug is configured to be inserted in the inlet cassette outlet flow path. The inlet and outlet plugs are configured to be removable and reinsertable. A separation layer is disposed between the inlet cassette plate and the outlet cassette plate.

### RELATED APPLICATIONS

This application claims the benefit under 35 U.S.C. § 119 (e) of U.S. Provisional Patent Application No. 63/455,870 filed on Mar. 30, 2023 titled MODULAR FLUID FILTRATION CASSETTE ASSEMBLY, which is hereby incorporated by reference in its entirety.

### TECHNOLOGICAL FIELD

The present disclosure is generally related to a filtration cassette assembly. More particularly, the present disclosure is related to a modular fluid filtration cassette assembly.

### BACKGROUND

Fluid filtration cassettes may be used, for example, in membrane chromatography, tangential flow filtration (TFF), various microfiltration applications, etc. Various situations require larger filtration volumes or faster filtration. Such situations may thus require more than one cassette to be used simultaneously. For example, various parallel and serial cassette assemblies may be used. An improper number of cassettes, an improper alignment of cassettes in an assembly, an improper level of pressure within the cassette assembly, and other factors can interfere with operations of the components and equipment.

It can also be desirable to promote uniform fluid flow laterally across a first side of a separation layer disposed within the cassette, axially through the separation layer, and laterally across an opposite side of the separation layer once the fluid has passed through the separation layer. Such uniform flow may improve fluid filtration. Uniform flow may also result in more consistent and more easily controlled pressures within the individual cassettes and within the cassette assembly. Consequently, the fluid filtration cassette may have an inlet channel that brings fluid to a separation layer in a manner which promotes uniform flow.

It can also be desirable to remove gases from the cassette assembly to promote consistent pressure and fluid flow during filtration.

### SUMMARY

The technology disclosed herein relates to a cassette assembly that has a modular configuration, which allows for the assembly to be adaptable to a variety of operating conditions and environments. Filtration assemblies can incorporate one or more cassettes and can be modified relatively easily to incorporate additional cassettes or fewer cassettes. In filtration assemblies having multiple cassettes, such cassettes are arranged in parallel for fluid filtration. A fluid inlet of a cassette may be fluidically coupled to each of the cassettes in the assembly for parallel filtration through each of the cassettes in the assembly. A fluid outlet of a cassette may be fluidically coupled to each of the cassettes in the assembly for parallel filtration through each of the cassettes in the assembly. The cassettes are each configured to receive removable plugs to selectively obstruct a particular flow path defined by a particular cassette based on the position of the cassette within the assembly. Such a configuration further allows for modularity of the cassette assembly.

In one or more embodiments, the cassette assembly includes an inlet cassette plate. The inlet cassette plate defines an inlet cassette inlet flow path and an inlet cassette outlet flow path. The inlet cassette inlet flow path and the inlet cassette outlet flow path extend axially through the inlet cassette plate. The cassette assembly further includes an outlet cassette plate. The outlet cassette plate is configured to be arranged in a stack with the inlet cassette plate. The outlet cassette plate defines an outlet cassette inlet flow path and an outlet cassette outlet flow path. The outlet cassette inlet flow path and the outlet cassette outlet flow path extend axially through the outlet cassette plate. The inlet cassette inlet flow path is configured to be laterally aligned with the outlet cassette inlet flow path. The inlet cassette outlet flow path is configured to be laterally aligned with the outlet cassette outlet flow path. The cassette assembly further includes an inlet plug. The inlet plug is configured to be inserted in the outlet cassette inlet flow path to seal the outlet cassette inlet flow path. The inlet plug is configured to be removable and reinsertable in the outlet cassette inlet flow path. The cassette assembly further includes an outlet plug. The outlet plug is configured to be inserted in the inlet cassette outlet flow path to seal the inlet cassette outlet flow path. The outlet plug is configured to be removable and reinsertable in the inlet cassette outlet flow path. The cassette assembly further includes a separation layer. The separation layer is disposed between the inlet cassette plate and the outlet cassette plate. The inlet cassette inlet flow path is configured to be in fluid communication with the outlet cassette outlet flow path through the separation layer to form an assembly flow path.

In some embodiments, the inlet cassette plate, the outlet cassette plate, the inlet plug, the outlet plug, and the separation layer define a single cassette. Additionally or alternatively, the inlet cassette plate, the outlet cassette plate, the inlet plug, the outlet plug, and the separation layer define more than one cassette.

Additionally or alternatively, the cassette assembly further includes an inlet channel extending along an effective inlet surface area of the separation layer in fluid communication with the inlet cassette inlet flow path, and further includes an outlet channel extending along an effective outlet surface area of the separation layer towards the outlet cassette outlet flow path. Additionally or alternatively, the cassette assembly further includes an inlet flow path extension defined by the inlet cassette plate configured to fluidically couple the inlet cassette inlet flow path and the inlet channel, and further includes an outlet flow path extension defined by the outlet cassette plate configured to fluidically couple the outlet cassette outlet flow path and the outlet channel. Additionally or alternatively the inlet flow path extension includes an inlet extension first portion extending laterally from the inlet cassette inlet flow path towards the inlet channel, and an inlet extension second portion extending laterally along a width of the effective inlet surface area. Additionally or alternatively, the outlet flow path extension includes an outlet extension first portion extending laterally from the outlet cassette outlet flow path towards the outlet channel, and an outlet extension second portion extending laterally along a width of the effective outlet surface area.

Additionally or alternatively, the cassette assembly further includes a separation layer seal installed between the inlet cassette plate and the outlet cassette plate. The separation layer seal is in contact with the inlet cassette plate and the outlet cassette plate. The separation layer seal is configured to fluidically seal a perimeter region of the separation layer, a perimeter region of the inlet channel, and a perimeter region of the outlet channel. Additionally or alternatively, the separation layer seal has an overmolded gasket.

Additionally or alternatively, the inlet cassette plate defines a first port in selective fluid communication with the inlet cassette inlet flow path, and the first port laterally extends through an axial surface of the inlet cassette plate, and the outlet cassette plate defines a second port in selective fluid communication with the outlet cassette outlet flow path, and the second port laterally extends through an axial surface of the outlet cassette plate, and the cassette assembly has a first port plug configured to seal the first port, and the first port plug is removable and reinsertable in the first port, and the cassette assembly has a second port plug configured to seal the second port, and the second port plug is removable and reinsertable in the second port.

Additionally or alternatively, the separation layer has a membrane stack having a plurality of membrane layers, and the plurality of membrane layers includes at least 10 membrane layers. Additionally or alternatively, the separation layer has an effective inlet surface area defined by an effective length and an effective width, and the effective length is at least 2.5 times the effective width.

Additionally or alternatively, the cassette assembly further includes an outlet channel spacer positioned in the outlet channel, where the outlet channel spacer is configured to accommodate fluid flow. Additionally or alternatively, the cassette assembly further includes an inlet channel spacer positioned in the inlet channel, where the inlet channel spacer is configured to accommodate fluid flow. Additionally or alternatively, at least one of the inlet channel spacer and the outlet channel spacer has lateral ridges extending across the separation layer.

Additionally or alternatively, the outlet cassette plate includes an alignment feature and the inlet cassette plate includes a mating alignment feature, and the alignment feature is laterally aligned with the mating alignment feature to operatively couple the outlet cassette plate and the inlet cassette plate.

Additionally or alternatively, the cassette assembly further includes a first end plate operatively couplable to the inlet cassette plate, and a second end plate operatively couplable to the outlet cassette plate. The first end plate includes a first inlet port configured to extend to the inlet cassette inlet flow path, and the second end plate includes a second outlet port configured for fluid communication with the outlet cassette outlet flow path.

Additionally or alternatively, the cassette assembly further includes a fastener configured to operatively couple the inlet cassette plate and the outlet cassette plate. Additionally or alternatively, the cassette assembly has a fastener configured to operatively couple the first end plate, the inlet cassette plate, the outlet cassette plate, and the second end plate. Additionally or alternatively, the fastener includes a bolt, and the inlet cassette plate defines a first axial through-hole, and the outlet cassette plate defines a second axial through-hole. The first axial through-hole and the second axial through-hole are configured to laterally align to receive the bolt. Additionally or alternatively, the cassette assembly has a first nut configured to receive one end of the bolt and a second nut configured to receive an opposite end of the bolt, and the first and second nuts are configured to apply a compression force to the cassette assembly. Additionally or alternatively, the first end plate defines a third axial through-hole and the second end plate defines a fourth axial through-hole, and each of the first, second, third, and fourth axial through-holes are configured to be laterally aligned to receive the bolt.

Additionally or alternatively, the cassette assembly further includes an attachment seal between the inlet cassette plate and the outlet cassette plate. The attachment seal extends laterally around and outside of a periphery of the separation layer.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE DRAWINGS

FIG. 1 is a first perspective view of an example fluid filtration cassette assembly consistent with various embodiments.

FIG. 2 is a second perspective view consistent with the example of FIG. 1.

FIG. 3A is a third perspective cross-section view consistent with the example of FIGS. 1-2.

FIG. 3B is a partial close-up view of FIG. 3A.

FIG. 3C is a second partial close-up view of FIG. 3A.

FIG. 4 is a partial close-up view of FIG. 3A.

FIG. 5 is an exploded perspective view of an example cassette consistent with some examples.

FIG. 6 is another exploded perspective view of the example cassette of FIG. 5.

FIG. 7 is a detail view of a cross-section of a portion of a cassette assembly consistent with FIGS. 1-4.

FIG. 8 is a facing view of an example channel spacer consistent with some examples.

FIG. 9 is a partial exploded view of an example cassette assembly consistent with some examples.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

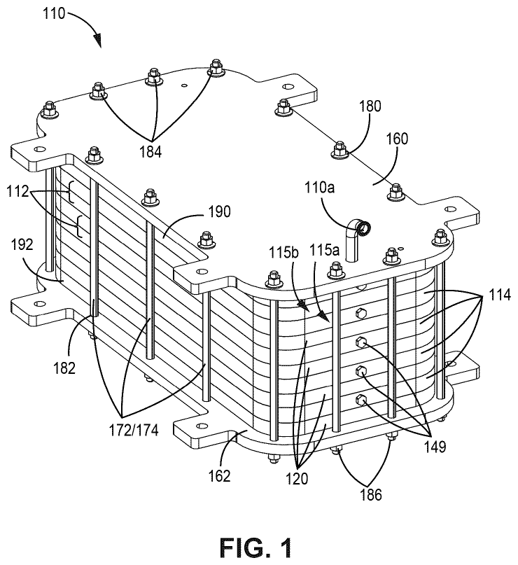

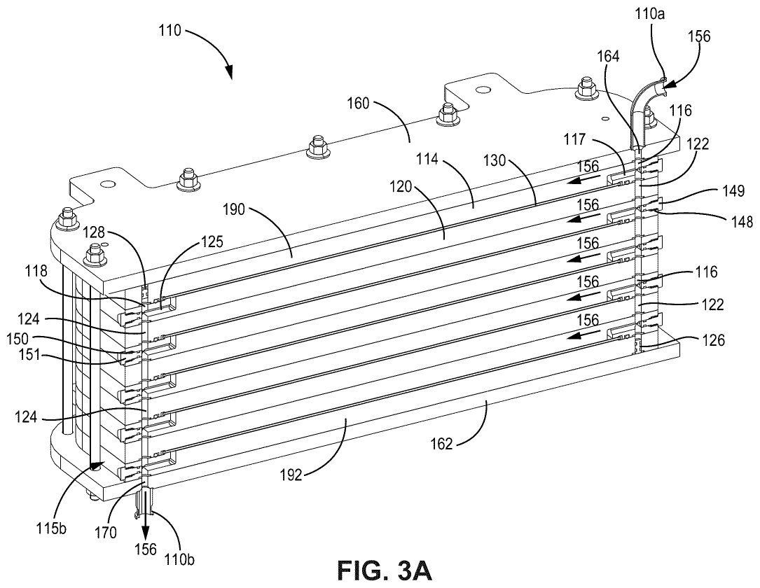

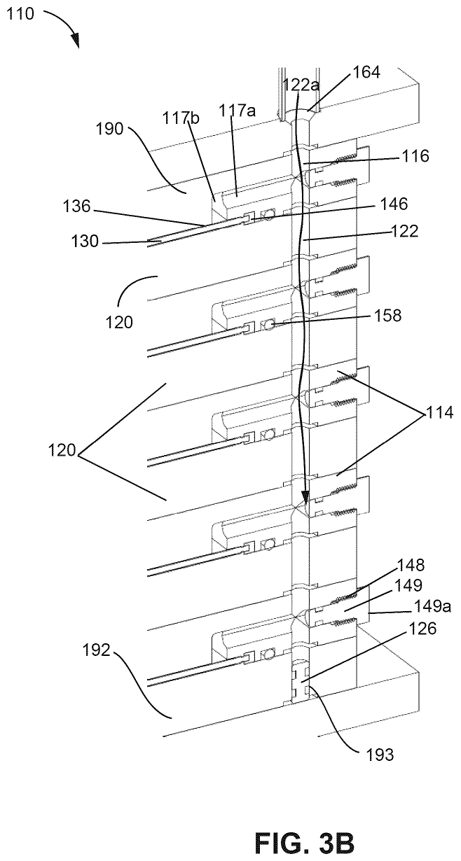

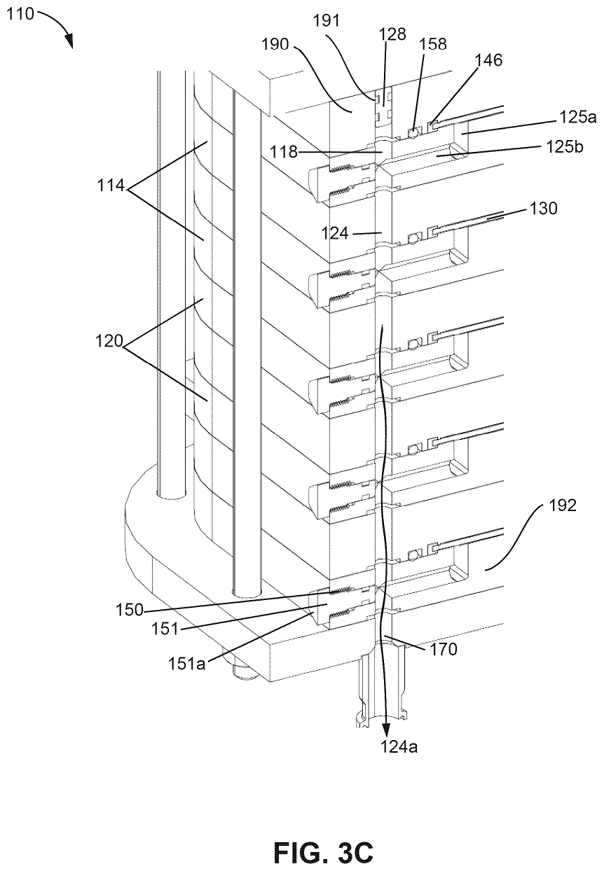

Cassette assemblies consistent with the technology disclosed herein can have a variety of different configurations. FIGS. 1-3C and 6 depict one example embodiment of a cassette assembly 110, and FIGS. 1-3C and 6 can be viewed together with the following description. The cassette assembly 110 is generally configured to filter a fluid that is passed therethrough. The cassette assembly 110 generally has an inlet cassette plate 114, an outlet cassette plate 120, an inlet plug 126, an outlet plug 128, and a separation layer 130. As illustrated in FIGS. 1-3C, there are a plurality of cassettes 112 stacked within the cassette assembly 110. Each of the plurality of cassettes 112 are configured to filter fluid passing therethrough, and the cassettes 112 are generally arranged in parallel with respect to fluid flow through the cassette assembly 110. Parallel fluid flow through multiple cassettes can accommodate increased filtration capacity and/or reduced pressure drop compared to fluid flow through a single cassette or compared to fluid flow through cassettes arranged in series. Parallel fluid flow 156 through the assembly 110 is represented in FIG. 3A. In some implementations, however, there may be a single cassette 112 within the cassette assembly 110, as described further herein.

As illustrated in FIG. 3B, the cassette assembly 110 has a fluid inlet flow path 122a. The fluid inlet flow path 122a fluidically couples an assembly inlet 110a of the cassette assembly 110 to each of the individual cassettes 112 within the assembly 110. The fluid inlet flow path 122a extends axially through each of the cassettes 112 in the cassette assembly 110. As illustrated in FIG. 3C, the cassette assembly 110 has a fluid outlet flow path 124a. The fluid outlet flow path 124a fluidically couples an assembly outlet 110b of the cassette assembly 110 to each of the individual cassettes 112 within the assembly. The fluid outlet flow path 124a extends axially through each of the cassettes 112 in the cassette assembly 110. The fluid inlet flow path 122a and the fluid outlet flow path 124a are in fluid communication through each of the cassettes 112. More particularly, the fluid inlet flow path 122a and the fluid outlet flow path 124a are in fluid communication through each separation layer 130 of each cassette 112. The present disclosure does not limit the flow direction to any specific orientation.

The cassette assembly 110 described herein is modular, and a user is able to include different numbers of cassettes 112 into the cassette assembly 110. This may be advantageous as the cassette assembly 110 can be optimized to accommodate a variety of different operating conditions.

Each individual cassette 112 within the cassette assembly 110 has an inlet cassette plate 114, an outlet cassette plate 120, and a separation layer 130 disposed between the inlet cassette plate 114 and the outlet cassette plate 120. The outlet cassette plate 120 can be configured to be arranged in a stack with the inlet cassette plate 114. In some embodiments the assembly 110 has a single inlet cassette plate 114 and a single outlet cassette plate 120 in an assembly that has a single cassette 112. In some implementations, such as in the assembly of FIGS. 1-3C, the assembly 110 includes more than one inlet cassette plate 114 and more than one outlet cassette plate 120 where there is more than one cassette 112 in the assembly 110.

Each inlet cassette plate 114 can define an inlet cassette inlet flow path 116 (particularly visible in FIG. 3B) and an inlet cassette outlet flow path 124 (FIG. 3C). The inlet cassette inlet flow path 116 defines a path for inlet fluid flow from the assembly inlet 110a into the cassette 112 during a fluid filtration application. The inlet cassette outlet flow path 124 defines a path for outlet fluid flow out of the cassette 112 during a fluid filtration application. The inlet cassette inlet flow path 116 can extend axially through the inlet cassette plate 114. The inlet cassette outlet flow path 124 can extend axially through the inlet cassette plate 114. The inlet cassette inlet flow path 116 is generally configured for fluid communication with the inlet cassette outlet flow path 124.

The outlet cassette plate 120 of each cassette assembly 110 can define an outlet cassette inlet flow path 122 (FIG. 3B) and an outlet cassette outlet flow path 118 (FIG. 3C). The outlet cassette inlet flow path 122 defines a path for inlet fluid flow during a fluid filtration application. The outlet cassette outlet flow path 118 defines a path for outlet fluid flow during a fluid filtration application. The outlet cassette inlet flow path 122 can extend axially through the outlet cassette plate 120. The outlet cassette outlet flow path 118 can extend axially through the outlet cassette plate 120. The outlet cassette inlet flow path 122 can be generally configured for fluid communication with the inlet cassette inlet flow path 116, as described further herein. The outlet cassette inlet flow path 122 can be generally configured for fluid communication with the outlet cassette outlet flow path 118. The outlet cassette inlet flow path 122 can be generally configured for fluid communication with the inlet cassette outlet flow path 124.

The inlet cassette inlet flow path 116 can be configured to be laterally aligned with the outlet cassette inlet flow path 122, which together form a portion of the fluid inlet flow path 122a of the assembly 110. “Laterally aligned” is used herein to mean that the inlet flow paths 116, 122 overlap in the lateral direction. The lateral direction is defined as any direction orthogonal to the axial direction. The axial direction is parallel to the direction of stacking of the inlet cassette plate 114 and the outlet cassette plate 120. In some embodiments, the inlet cassette inlet flow path 116 and the outlet cassette inlet flow path 122 are configured for fluid communication to accommodate fluid flow, such as in the axial direction. As such, the fluid inlet flow path 122a can extend axially through the cassette assembly 110, including each inlet cassette plate 114 and each outlet cassette plate 120. Each outlet cassette outlet flow path 118 can be configured to be laterally aligned with each inlet cassette outlet flow path 124, which together form a portion of the fluid outlet flow path 124a of the cassette assembly 110. The fluid outlet flow path 124a extends axially through the cassette assembly 110, including the inlet cassette plate 114 and the outlet cassette plate 120.

In various embodiments, the inlet cassette inlet flow path 116 and the outlet cassette outlet flow path 118 are in fluid communication via the separation layer 130 of the cassette 112. The separation layer 130 is disposed between the inlet cassette plate 114 and the outlet cassette plate 120. The separation layer 130 is generally configured to filter a fluid stream flowing from the inlet cassette inlet flow path 116 to the outlet cassette outlet flow path 118. The separation layer is configured to separate at least one component in the fluid stream from the fluid stream. Such separation may be realized through one or more of the following processes: chemical binding, binding of biological molecules, particle capture, absorption, adsorption, etc., as the fluid flows along and/or through the separation layer. The separation layer may include a single layer or a plurality of layers. The separation layer 130 is a fibrous mass in some embodiments. In some embodiments the separation layer 130 can be a particulate mass. The separation layer 130 is a single membrane in some embodiments. The separation layer 130 is a membrane stack in some embodiments. A membrane stack may include a plurality of membranes which are consecutively layered in the axial direction. The inlet cassette inlet flow path 116 can be configured to be in fluid communication with the outlet cassette outlet flow path 118 through the separation layer 130.

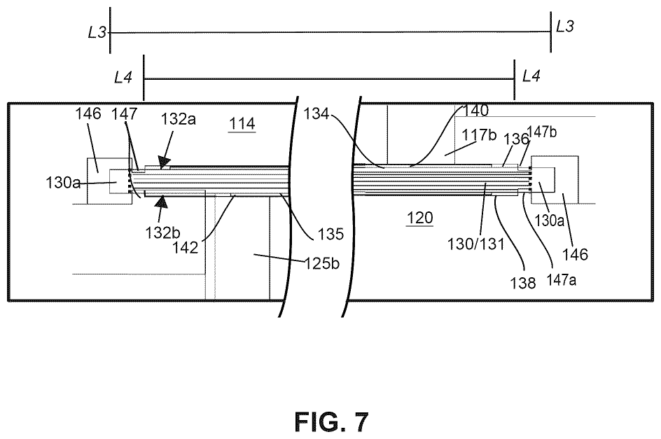

In embodiments where the separation layer 130 includes a membrane stack, the separation layer 130 can include a plurality of membrane layers 131 (shown in FIG. 7). The plurality of membrane layers 131 can be between 1 and 50 membrane layers 131. In embodiments, the plurality of membrane layers 131 can include at least 10 membrane layers 131. In alternative embodiments, the plurality of membrane layers 131 can include at least 5, at least, 15, at least 19, at least 20, at least 30, at least 40, or at least 50 membrane layers 131, etc. In alternative embodiments, the plurality of membrane layers 131 can include less than 50, less than 45, less than 35, less than 25, less than 17, less than 9, less than 4 membrane layers 131 etc.

The membrane layers 131 can be constructed of a variety of different materials and combinations of materials. In various embodiments the membrane layers 131 incorporate a breathable membrane, such as polytetrafluoroethylene (PTFE) or other types of breathable membranes. The membrane layers 131 can be a laminate or composite that includes a breathable membrane, such as a PTFE laminated to a woven or non-woven support layer. In some embodiments the membrane layers 131 incorporate a microporous substrate. In some embodiments each of the membrane layers 131 is constructed of the same or a similar material. In some embodiments one or more of the membrane layers 131 are constructed of a different material than other membrane layers 131.

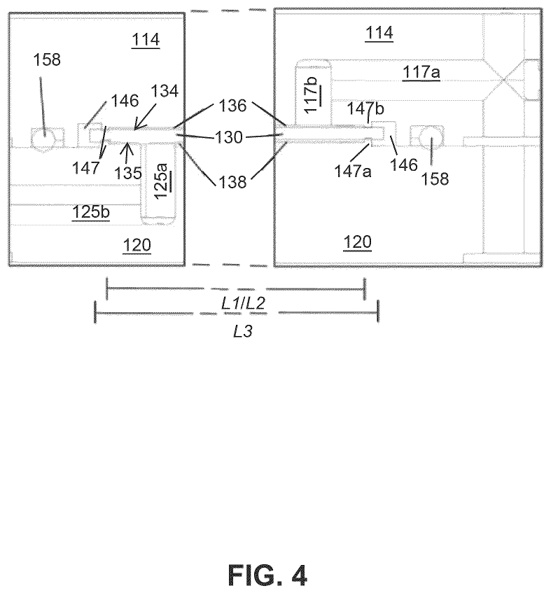

FIG. 7 illustrates a detail view of a cross-section of a portion of a cassette assembly consistent with FIGS. 1-3C. Each cassette 112 can further include an inlet channel 136 and an outlet channel 138 (as illustrated in FIG. 7). The inlet channel 136 generally defines a path for fluid flow from the inlet cassette inlet flow path 116 (FIG. 3B) along a first lateral surface 134 (FIG. 4) of the separation layer 130. The outlet channel 138 generally defines a path for fluid flow along a second lateral surface 135 (FIG. 4) of the separation layer 130, which is opposite the first lateral surface 134. The outlet channel 138 extends from the separation layer 130 to the outlet cassette outlet flow path 118 (FIG. 3C).

The inlet channel 136 extends along an effective inlet surface area 132a of the separation layer 130. The “effective inlet surface area” 132A is defined as the surface area of the upstream surface of the separation layer 130, which is the first lateral surface 134, that is exposed to the inlet channel 136. The effective inlet surface area 132a is partially defined by an effective length L4 (illustrated in FIG. 7). Conversely, the total length of the separation layer 130 is defined by L3. The difference between L3 and L4 may be a result of features obstructing fluid flow through portions of the surfaces separation layer, such as a separation layer seal 146 (discussed further herein) or structures defined by the cassette plates 114, 120. The inlet channel 136 can extend laterally from the inlet cassette inlet flow path 116. The inlet channel 136 can extend axially between the inlet cassette plate 114 and the effective inlet surface area 132a of the separation layer 130. In some embodiments, the inlet channel 136 can have an axial depth that accommodates axial expansion of the separation layer 130 resulting from fluid flow through the separation layer 130 with a portion of the axial depth remaining clear of the separation layer 130 to accommodate fluid flow. In embodiments with a membrane stack, for example, the inlet channel 136 can be sized depending on, for example, the number of membrane layers 131, the material of the membrane layers 131, the desired fluid flow rate through the assembly 110, etc.

The outlet channel 138 extends along an effective outlet surface area 132b of the separation layer 130. The “effective outlet surface area” is defined as the surface area of the downstream surface of the separation layer 130, which is the second lateral surface 135, that is exposed to the outlet channel 138. The outlet channel 138 can extend laterally towards the outlet cassette outlet flow path 118. The outlet channel 138 can be in fluid communication with the outlet cassette outlet flow path 118. The outlet channel 138 can extend axially between the effective outlet surface area 132b of the separation layer 130 and the outlet cassette plate 120. In some embodiments, the outlet channel 138 can have an axial depth that accommodates axial expansion of the separation layer 130 resulting from fluid flow through the separation layer 130 with a portion of the axial depth remaining clear of the separation layer 130 to accommodate fluid flow. In embodiments with a membrane stack, for example, the outlet channel 138 can be sized depending on, for example, the number of membrane layers 131, the material of the membrane layers 131, the desired fluid flow rate through the assembly 110, etc.

In some embodiments, the inlet channel 136 can be defined by at least one of the inlet cassette plate 114, the separation layer 130, the effective inlet surface area 132a, and the inlet cassette inlet flow path 116. The outlet channel 138 can be defined by at least one of the outlet cassette plate 120, the separation layer 130, the effective outlet surface area 132b, and the outlet cassette outlet flow path 118. In some embodiments, the channels 136, 138 may be defined by any combination of the listed components, and additionally can be defined by one or more seals, discussed further herein.

Each cassette 112 can further include an inlet flow path extension 117 (e.g., 117a, 117b) and an outlet flow path extension 125 (e.g., 125a, 125b), as illustrated in FIGS. 3A-3C and partially visible in FIG. 7. These extensions are configured to fluidically couple the inlet and outlet flow paths to the inlet and outlet channels, respectively. The inlet flow path extension 117 can be defined by the inlet cassette plate 114. The inlet flow path extension 117 can be configured to fluidically couple the inlet cassette inlet flow path 116 and the inlet channel 136. The inlet flow path extension 117 can include a first portion 117a and a second portion 117b (see FIG. 3B). The first portion 117a can extend laterally from the inlet cassette inlet flow path 116 towards the inlet channel 136. In the current example, the second portion 117b extends axially from the first portion 117a to the inlet channel 136. The second portion 117b can be in fluid communication with the inlet channel 136 towards one lateral end of the inlet channel. In some embodiments, the second portion 117b can be in fluid communication with the inlet channel 136 at one lateral end of the inlet channel 136.

The outlet flow path extension 125 (FIG. 3C) can be defined by the outlet cassette plate 120. The outlet flow path extension 125 can fluidically couple the outlet cassette outlet flow path 118 (FIG. 3C) and the outlet channel 138 (FIG. 7). The outlet flow path extension 125 can include a first portion 125a and a second portion 125b (see FIG. 3C). The first portion 125a can extend axially from the outlet channel 138 to the second portion 125b. The second portion 125b can extend laterally from the first portion 125a to the outlet cassette outlet flow path 118. The first portion 125a can be fluidically coupled to the outlet channel 138 towards the opposite end of the effective length L4 (illustrated in FIG. 7) of the separation layer 130 relative to the inlet extension first portion 117a.

In alternative embodiments, the extensions do not define 90-degree segments relative to each other or the corresponding fluid flow path as shown and can instead define one or more curved segments. In further alternative embodiments, the inlet extension is a single segment that extends at an oblique angle from the inlet cassette inlet flow path 116 to the inlet channel 136 such that the inlet extension is not orthogonal to the inlet cassette inlet flow path 116 or the inlet channel 136. Similarly, the outlet extension 125 may define a single or multiple segments where at least one segment is curved. In some embodiments the outlet extension is a single segment that defines an oblique angle and extends from the outlet channel 138 to the outlet cassette outlet flow path 118 such that the outlet extension is not orthogonal to the outlet cassette outlet flow path 118 or the outlet channel 138.

The inlet cassette plate 114 and the outlet cassette plate 120 can be constructed of a variety of different materials and combinations of materials. In some embodiments, one or both of the cassette plates 114, 120 is plastic. In other embodiments, one or both of the cassette plates 114, 120 is metal. In one example, one or both of the cassette plates 114, 120 are injection-molded, 3D printed, machined, or combinations thereof. In some embodiments the inlet cassette plate 114 is constructed of the same material as the outlet cassette plate 120. In some other embodiments the inlet cassette plate 114 is constructed of a different material than the outlet cassette plate 120.

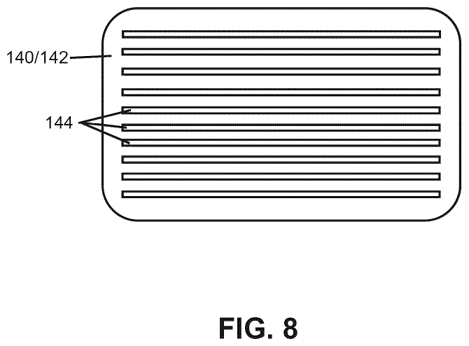

FIG. 8 illustrates a laterally facing view of an example channel spacer, which may be inserted into the inlet and/or outlet channels 136, 138 to ensure, for example, that the separation layer 130 does not expand into and block the channels. Each cassette 112 can further include one or more channel spacers 140, 142 that are each configured to be received by the inlet channel 136 and/or the outlet channel 138. In the current example, the cassette assembly 110 has an inlet channel spacer 140 (as illustrated in FIGS. 7-8). The inlet channel spacer 140 is generally configured to retain a minimum axial depth of the inlet channel 136 to maintain fluid flow along the inlet channel 136. As mentioned above, the axial depth of the inlet channel 136 may be reduced upon system use due to separation layer expansion, for example, and the inlet channel spacer 140 may advantageously oppose such expansion. The inlet channel spacer 140 can be positioned in the inlet channel 136. The inlet channel spacer 140 is positioned between the inlet cassette plate 114 and the separation layer 130. In some embodiments, the inlet channel spacer 140 abuts the inlet cassette plate 114 and the separation layer 130.

Each cassette 112 can further include an outlet channel spacer 142. The outlet channel spacer 142 is generally configured to retain a minimum axial depth of the outlet channel 138 to accommodate fluid flow along the outlet channel 138. The axial depth of the outlet channel 138 may be reduced upon system use due to separation layer expansion, and the outlet channel spacer 142 may advantageously oppose such expansion. The outlet channel spacer 142 can be positioned in the outlet channel 138. The outlet channel spacer 142 is positioned between the outlet cassette plate 120 and the separation layer 130. In some embodiments, the outlet channel spacer 142 abuts the outlet cassette plate 120 and the separation layer 130.

The inlet channel spacer 140 and/or the outlet channel spacer 142 may be constructed of a variety of different materials and combinations of materials. In some embodiments, the spacer 140, 142 is plastic. The spacer can be a woven or non-woven material such as a scrim layer. In other embodiments, the spacer 140, 142 is a metal. In one example, the spacer 140, 142 is injection-molded, 3D printed or the like. The spacer 140, 142 can be constructed of an elastomeric material such as, for example, rubber, silicone, polyurethane, or other elastomeric materials. The spacer 140, 142 can be retained with friction and/or compression forces. Such friction forces can be among, for example, between the spacer 140, 142 and the separation layer 130, and between the spacer 140, 142 and the corresponding cassette plate 114, 120.

The channel spacers 140, 142 generally define lateral and axial openings to accommodate fluid flow through the channel spacers 140, 142 to the separation layer 130. In some embodiments, at least one of the inlet channel spacer 140 and the outlet channel spacer 142 can include lateral ridges 144 extending across the separation layer 130, an example of which is illustrated in FIG. 8. The lateral ridges 144 are generally configured to define a structure to retain the axial depth of the respective channel for fluid flow. The lateral ridges 144 may advantageously provide rigidity to the respective spacer. The lateral ridges 144 may further advantageously guide fluid flow across the respective surface area of the separation layer 130.

The lateral ridges 144 may extend laterally along at least a portion of the channel length of the respective channel within which the spacer is positioned. The lateral ridges 144 may extend axially between the separation layer 130 and the adjacent cassette plate.

Each cassette 112 can further include a separation layer seal 146 (FIGS. 3B-C, 4, and 7). The separation layer seal 146 is generally configured to seal among the separation layer and each of the inlet cassette plate 114 and the outlet cassette plate 120 so that fluid does not escape from between the plates during fluid filtration. The separation layer seal 146 can be installed between the inlet cassette plate 114 and the outlet cassette plate 120. In some embodiments, the separation layer seal 146 can be in contact with the inlet cassette plate 114 and the outlet cassette plate 120. The separation layer seal 146 can be configured to fluidically seal a perimeter region 130a of the separation layer 130 (partially visible in FIG. 7), a perimeter region (not shown) of the inlet channel 136, and a perimeter region (not shown) of the outlet channel 138. In some embodiments, the separation layer seal 146 is defined by a relatively tight coupling of the cassette plates 114, 120 that forms a liquid tight seal via compression forces around the separation layer 130. In such an example, a separation layer seal that is a separate component than the cassette plates 114, 120 can be omitted.

The separation layer seal 146 may be constructed of a variety of different materials and combinations of materials. In various embodiments the separation layer seal 146 can be constructed of an elastomeric material such as rubber, silicone, polyurethane, and the like. In some other embodiments, the separation layer seal 146 is a molded plastic. In yet other embodiments, the separation layer seal 146 is a metal. In one example, the separation layer seal 146 is injection-molded, 3D printed or formed through other types of processes. The separation layer seal 146 can include an overmolded gasket. The overmolded gasket can be injection molded around the perimeter of the separation layer 130 to form the separation layer seal 146.

In alternative embodiments, the separation layer seal can be more than one seal. The separation layer seal 146 can include a first o-ring inserted between the perimeter region 130a on the first lateral surface 134 (such as the upstream surface) of the separation layer 130 and the inlet cassette plate 114. The separation layer seal 146 can include a second o-ring inserted between the perimeter region 130a on a second lateral surface 135 (such as the downstream surface) of the separation layer 130 and the outlet cassette plate 120. In further alternative embodiments, the separation layer seal 146 may be a weld, for example, or an adhesive. A weld may be formed between, or an adhesive may be used to seal together, the cassette plates 114, 120, or the separation layer 130 and the inlet cassette plate 114, or the separation layer 130 and the outlet cassette plate 120, or any combination thereof.

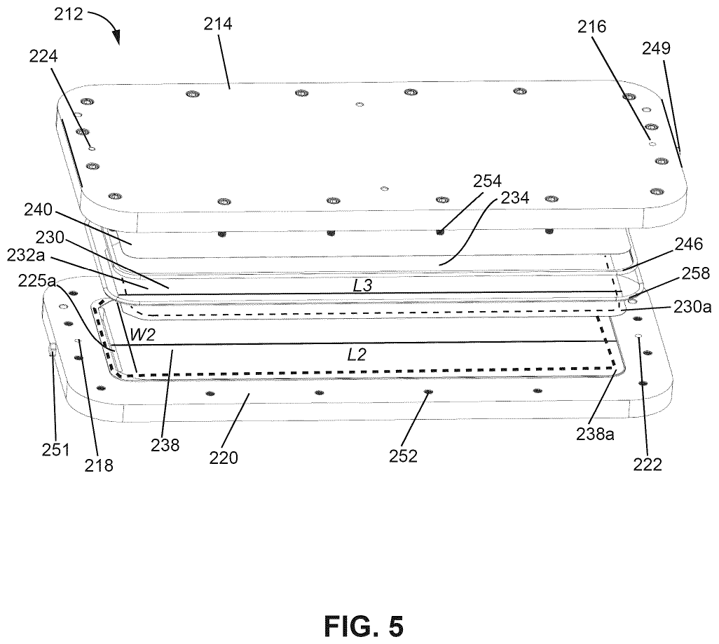

As illustrated in FIGS. 4 and 5, in some embodiments, the inlet cassette plate 114 and the outlet cassette plate 120 mutually define a compression structure 147 around the inlet channel 136 and the outlet channel 138. More particularly, in the current example the outlet cassette plate 120 defines an axially extending sidewall 147a around the outlet channel 138 that faces an opposing sidewall 147b of the inlet cassette plate 114 that surrounds the inlet channel 136. The axially extending sidewall 147a and the opposing sidewall 147b exert a compression force on the perimeter region 130a of the separation layer 130 that creates a fluid seal. The compression structure 147 may advantageously prevent fluid bypass therethrough.

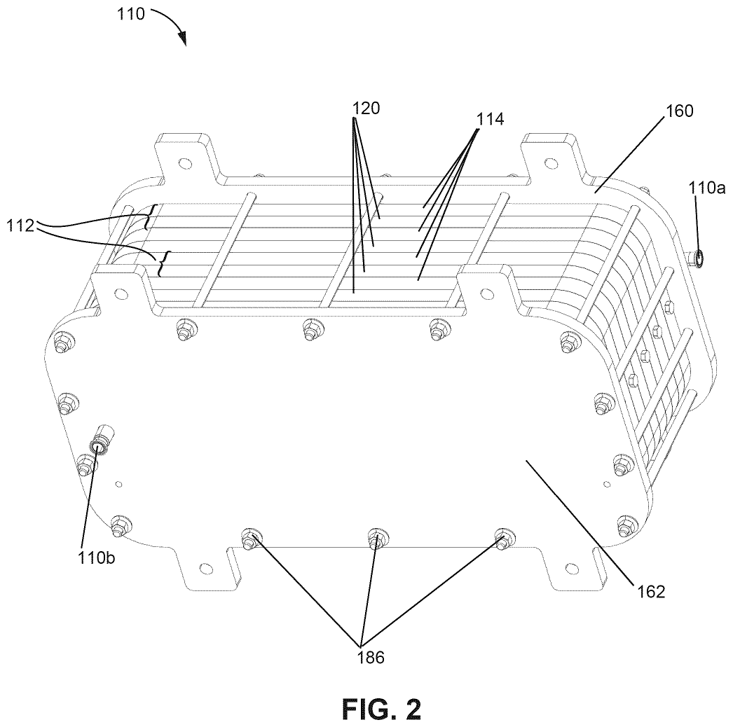

Each cassette 112 can further include an attachment seal 158 (FIGS. 3B-C and 4). The attachment seal 158 is generally configured to fluidically seal between the inlet and outlet cassette plates 114, 120. The attachment seal 158 can be inserted between the inlet cassette plate 114 and the outlet cassette plate 120. The attachment seal 158 can extend laterally around and outside of a periphery of the separation layer 130. The attachment seal 158 can be positioned laterally between the axial surfaces 115a, 115b (FIGS. 1-2) of the inlet and outlet cassette plates 114, 120, respectively, and the separation layer seal 146. The attachment seal 158 can be constructed of a variety of different materials and combinations of materials consistent with those discussed above with reference to the separation layer seal. The attachment seal 158 may be retained with friction and/or compression forces, for example, and/or may be retained using the fastener 172. Such forces can be among the attachment seal 158, the first cassette plate 114 and the second cassette plate 120.

In some embodiments, each inlet cassette plate 114 can define a first port 148 (particularly visible in FIG. 3B). The first port 148 can be configured to accommodate sampling fluid or removing gas once the cassette assembly 110 has been assembled and/or a fluid filtration has begun. The first port 148 can be in selective fluid communication with the inlet cassette inlet flow path 116. The first port 148 can laterally extend through an axial surface 115a of the inlet cassette plate 114. The first port 148 can extend laterally from the axial surface 115a to the inlet cassette inlet flow path 116. The first port 148 can be axially aligned with the inlet flow path extension 117. “Axially aligned” is used herein to mean that the first port 148 and the inlet flow path extension 117 (particularly the first portion 117a) overlap in the axial direction. The first port 148 and the first portion 117a of the inlet flow path extension 117 can be configured for fluid communication to accommodate fluid flow, such as in the lateral direction. The cassette assembly 110 can further include a first port plug 149. The first port plug 149 can be configured to seal the first port 148. The first port plug 149 can be removable and reinsertable in the first port 148. In some embodiments the first port plug 149 is configured to be permanently sealably disposed in the first port 148.

The outlet cassette plate 120 can define a second port 150 in selective fluid communication with the outlet cassette outlet flow path 118. The second port 150 can laterally extend through an axial surface 115b of the outlet cassette plate 120. The cassette assembly 110 can further include a second port plug 151. The second port plug 151 can be configured to seal the second port 150. The second port plug 151 can be removable and reinsertable in the second port 150. In some embodiments the second port plug 151 is configured to be permanently sealably disposed in the second port 150.

The port plugs 149, 151 may be constructed of a variety of different materials and combinations of materials. In some embodiments, the port plugs 149, 151 are a molded plastic. In other embodiments, the port plugs 149, 151 are a metal. In one example, the port plugs 149, 151 are injection-molded, 3D printed or the like. The port plugs 149, 151 can be constructed using, for example, a rubber, silicone, polyurethane, or other elastomeric material. The port plugs 149, 151 can be constructed of a combination of materials such as a metal with a plastic and/or elastomeric coating. In some embodiments, the port plugs 149, 151 can be threaded and screwed into the ports 148, 150, as illustrated in FIGS. 3A-3C. The port plugs 149, 151 can define threads in such embodiments. The port plugs 149, 151 may each have a head 149a, 151a that mates with, for example, a mating feature of one or more tools such as a screwdriver or a wrench. The port plugs 149, 151 can be removable by unscrewing them from the ports 148, 150. In the current example visible in FIGS. 1-2), the port plugs 149, 151 have hexagonal heads that align with, for example, a mating feature of a wrench for removal and reinsertion.

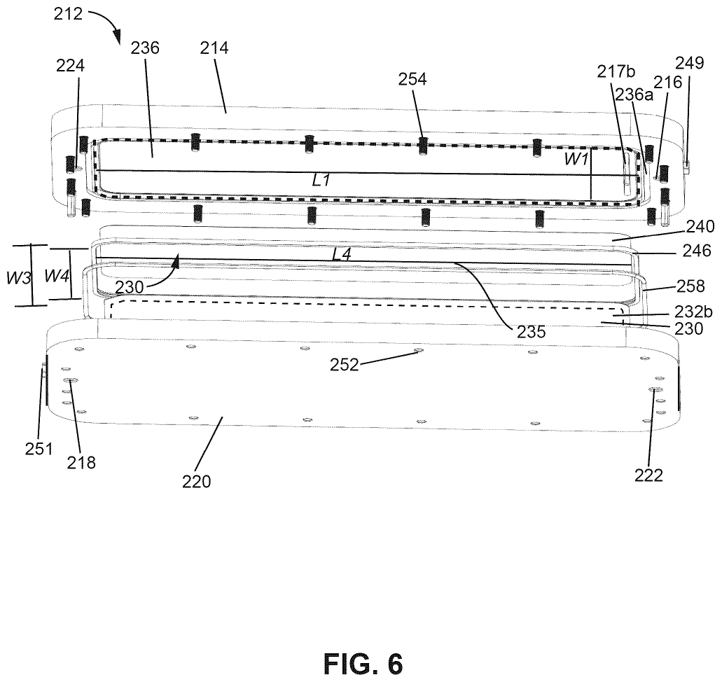

Cassette assemblies consistent with the technology disclosed herein can have a variety of different configurations. FIGS. 5-6 depict opposing exploded perspective views of another example cassette 212, and FIGS. 5-6 can be viewed together with the following description. The cassette 212 is generally configured to filter a fluid that is passed therethrough. The cassette 212 generally has an inlet cassette plate 214, an outlet cassette plate 220, and a separation layer 230.

The cassette 212 described herein is modular, and while the current drawing depicts an assembly that is a single cassette 212, different numbers of cassettes 212 can be incorporated into a cassette assembly, similar to the embodiment described in FIGS. 1-4 and 7. This may be advantageous as the cassette assembly can be optimized to accommodate a variety of different operating conditions. It will be understood the components referenced in the description of FIGS. 5-6 herein are consistent with the descriptions of the same components described elsewhere herein unless contradictory to the current description or corresponding figures.

Similar to other embodiments described herein, cassette 212 has an inlet cassette plate 214, an outlet cassette plate 220, and a separation layer 230 disposed between the inlet cassette plate 214 and the outlet cassette plate 220. The outlet cassette plate 220 can be configured to be arranged in a stack with the inlet cassette plate 214. Each inlet cassette plate 214 can define an inlet cassette inlet flow path 216 and an inlet cassette outlet flow path 224. The inlet cassette inlet flow path 216 defines a path for inlet fluid flow into the cassette 212 during a fluid filtration application. The inlet cassette outlet flow path 224 defines a path for outlet fluid flow out of the cassette 212 during a fluid filtration application. The inlet cassette inlet flow path 216 can extend axially through the inlet cassette plate 214. The inlet cassette outlet flow path 224 can extend axially through the inlet cassette plate 214. The inlet cassette inlet flow path 216 is generally configured for fluid communication with the inlet cassette outlet flow path 224.

The outlet cassette plate 220 can define an outlet cassette inlet flow path 222 and an outlet cassette outlet flow path 218. The outlet cassette inlet flow path 222 defines a path for inlet fluid flow during a fluid filtration application. The outlet cassette outlet flow path 218 defines a path for outlet fluid flow during a fluid filtration application. The outlet cassette inlet flow path 222 can extend axially through the outlet cassette plate 220. The outlet cassette outlet flow path 218 can extend axially through the outlet cassette plate 220. The outlet cassette inlet flow path 222 can be generally configured for fluid communication with the inlet cassette inlet flow path 216, as described further herein. The outlet cassette inlet flow path 222 can be generally configured for fluid communication with the outlet cassette outlet flow path 218. The outlet cassette inlet flow path 222 can be generally configured for fluid communication with the inlet cassette outlet flow path 224.

The inlet cassette inlet flow path 216 can be configured to be laterally aligned with the outlet cassette inlet flow path 222, as described above with respect to FIGS. 1-4 and 7. Each outlet cassette outlet flow path 218 can be configured to be laterally aligned with each inlet cassette outlet flow path 224, as described above with respect to FIGS. 1-4 and 7.

In various embodiments, the inlet cassette inlet flow path 216 and the outlet cassette outlet flow path 218 are in fluid communication via the separation layer 230 of the cassette 212. The separation layer 230 is disposed between the inlet cassette plate 214 and the outlet cassette plate 220. The separation layer 230 is generally configured to filter a fluid stream flowing from the inlet cassette inlet flow path 216 to the outlet cassette outlet flow path 218. The inlet cassette inlet flow path 216 can be configured to be in fluid communication with the outlet cassette outlet flow path 218 through the separation layer 230. The separation layer 230 can include a membrane stack, which can further include a plurality of membrane layers, as described herein with respect to FIGS. 1-4 and 7.

Each cassette 212 can further include an inlet channel 236 (as illustrated in FIG. 6) and an outlet channel 238 (as illustrated in FIG. 5). The inlet channel 236 generally defines a path for fluid flow from the inlet cassette inlet flow path 216 along a first lateral surface 234 of the separation layer 230 (FIG. 5). The outlet channel 238 generally defines a path for fluid flow along a second lateral surface 235 (FIG. 6) of the separation layer 230, which is opposite the first lateral surface 234. The outlet channel 238 extends from the separation layer 230 to the outlet cassette outlet flow path 218.

The inlet channel 236 (FIG. 6) extends along an effective inlet surface area 232a (FIG. 5) of the separation layer 230. The “effective inlet surface area” 232a is defined as the surface area of the upstream surface of the separation layer 230, which is the first lateral surface 234, that is directly exposed to the inlet channel 236. The inlet channel 236 is similar to the inlet channel 136 described herein with respect to FIGS. 1-4 and 7. The outlet channel 238 (FIG. 5) extends along an effective outlet surface area 232b (FIG. 6) of the separation layer 230. The “effective outlet surface area” is defined as the surface area of the downstream surface of the separation layer 230, which is the second lateral surface 235, that is exposed to the outlet channel 238. The outlet channel 238 is similar to the outlet channel 138 described herein with respect to FIGS. 1-4 and 7.

Each cassette 212 can further include an inlet flow path extension and an outlet flow path extension similar to those described herein with respect to FIGS. 3A-3C and partially visible in FIG. 7. FIG. 5, for example, illustrates an outlet flow path extension first portion 225a, and FIG. 6 illustrates an inlet flow path extension second portion 217b. The second portion 217b can extend laterally along at least a portion of the width W1 (as illustrated in FIG. 6) of the inlet channel 236. This may advantageously improve fluid flow uniformity across the entirety of the effective area of the separation layer 230. Similarly, in this example, the first portion 225a can extend laterally along at least a portion of the width W2 of the outlet channel 238 (as illustrated in FIG. 5). Such a configuration may advantageously improve fluid flow uniformity across the entirety of the effective area of the separation layer 230. Alternate examples are possible where one or both of the second portion 217b of the inlet flow path extension and the first portion 225a of the outlet flow path extension define an opening having a circular shape rather than an elongate slot.

The inlet channel 236 of the inlet cassette plate 214 defines an inlet channel length L1 and an inlet channel width W1, as illustrated in FIG. 6. In some embodiments, the ratio of the inlet channel length L1 to the inlet channel width W1 may advantageously result in a relative improvement in flow characteristics in filtration operations. The inlet channel length L/can be between 1 and 4 times larger than the inlet channel width W1. In alternative embodiments, the inlet channel length L1 can be at least 1 time, at least 1.5 times, at least 2 times, at least 2.5 times, at least 3 times, at least 3.5 times, at least 4 times the inlet channel width W1, etc., and/or can be less than 4 times, less than 3.75 times, less than 3.25 times, less than 2.75 times, less than 2.25 times, less than 1.75 times, less than 1.25 times the inlet channel width W1, etc.

The outlet channel 238 of the outlet cassette plate 220 can define an outlet channel length L2 and an outlet channel width W2, as illustrated in FIG. 5. The outlet channel length L2 can have a ratio with the outlet channel width W2 consistent with that discussed above with respect to the inlet channel length L1 and the inlet channel width W1.

The separation layer 230 generally defines an effective inlet surface area 232a and an effective outlet surface area 232b. The effective inlet surface area 232a has an effective length L4 and an effective width W4 (FIG. 6). The effective inlet surface area 232a can be defined as the area of the separation layer 230 which is available for filtration. The effective inlet surface area 232a will generally be less than a total surface area of the separation layer 230. The separation layer can define a total length L3 (FIG. 5) and a total width W3 (FIG. 6). In the current example, a perimeter region of the separation layer 230 is pinched between the inlet plate 214 and the outlet plate 220 and is not available for filtration, and thus does not define a portion of the effective area.

The effective length L4 can be between 1 times and 4 times larger than the effective width W4. In alternative embodiments, the effective length L4 can be at least 1 times, at least 1.5 times, at least 2 times, at least 2.5 times, at least 3 times, at least 3.5 times, or at least 4 times the effective width W4, etc. In alternative embodiments, the effective length L4 can be less than 4 times, less than 3.75 times, less than 3.25 times, less than 2.75 times, less than 2.25 times, less than 1.75 times, or less than 1.25 times the effective width W4, etc.

In some embodiments, the effective width W4 is equal to the width of the effective inlet surface area 232a and the width of the effective outlet surface area 232b. In alternative embodiments, the effective width W4 may be different at the effective inlet surface area 232a from the effective outlet surface area 232b such that there is an inlet effective width and an outlet effective width (not shown). In some embodiments, the effective length L4 is equal to the length of the effective inlet surface area 232a and the length of the effective outlet surface area 232b. In alternative embodiments, the effective length L4 of the effective inlet surface area 232a may be different than the effective length of the effective outlet surface area 232b such that there is an inlet effective length and an outlet effective length (not shown).

Each cassette 212 can further include one or more channel spacers that are each configured to be received by the inlet channel 236 and/or the outlet channel 238. In the current example, the cassette 212 has an inlet channel spacer 240 (as illustrated in FIGS. 5-6). The inlet channel spacer 240 may be similar to the inlet channel spacer 140 described with respect to FIGS. 1-4 and 7. Each cassette 212 can further include an outlet channel spacer (not shown for clarity of FIGS. 5-6). The outlet channel spacer may be similar to the outlet channel spacer 142 described with respect to FIGS. 1-4 and 7.

Each cassette 212 can further include a separation layer seal 246. The separation layer seal 246 is generally configured to seal among the separation layer and each of the inlet cassette plate 214 and the outlet cassette plate 220 so that fluid does not escape from between the plates during fluid filtration. The separation layer seal 246 can be installed between the inlet cassette plate 214 and the outlet cassette plate 220. In some embodiments, the separation layer seal 246 can be in contact with the inlet cassette plate 214 and the outlet cassette plate 220. The separation layer seal 246 can be configured to fluidically seal a perimeter region 230a of the separation layer 230 (FIG. 5), a perimeter region 236a of the inlet channel 236 (FIG. 6), and a perimeter region 238a of the outlet channel 238 (FIG. 5). The separation layer seal 246 may be similar to the separation layer seal 146 described with respect to FIGS. 1-4 and 7.

Each cassette 112 can further include an attachment seal 258. The attachment seal 258 is generally configured to fluidically seal between the inlet and outlet cassette plates 214, 220. The attachment seal 258 can be inserted between the inlet cassette plate 214 and the outlet cassette plate 220. The attachment seal 258 can extend laterally around a periphery of the separation layer seal 246. The attachment seal 258 may be similar to the attachment seal 158 described with respect to FIGS. 1-4 and 7.

In some embodiments, each inlet cassette plate 214 can define a first port similar to the first port 148 described herein with respect to FIGS. 1-4 and 7. The cassette 212 can further include a first port plug 249. The first port plug 249 can be configured to seal the first port. The first port plug 249 can be removable and reinsertable in the first port. In some embodiments the first port plug 249 is configured to be permanently sealably disposed in the first port.

The outlet cassette plate 220 can define a second port similar to the second port 150 described herein with respect to FIGS. 1-4 and 7. The cassette 212 can further include a second port plug 251. The second port plug 251 can be configured to seal the second port. The second port plug 251 can be removable and reinsertable in the second port. In some embodiments the second port plug 251 is configured to be permanently sealably disposed in the second port. The port plugs 249, 251 may be constructed of a variety of different materials and combinations of materials, and can be constructed with various threads, etc., as discussed herein with respect to FIGS. 1-4 and 7.

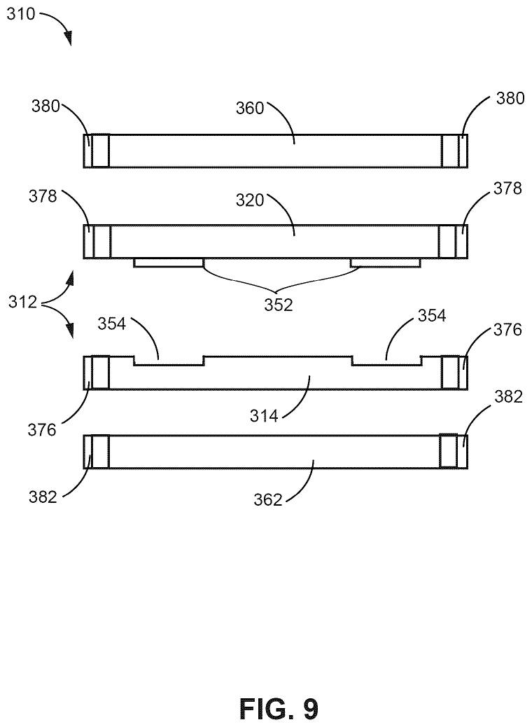

The outlet cassette plate 220 can include an alignment feature 252. The inlet cassette plate 214 can include a mating alignment feature 254 that is configured to mate with the alignment feature 252 when the cassette plates 214, 220 are properly aligned and stacked. FIGS. 5 and 6 illustrate a mating alignment feature 254 configured as one or more pins, and alignment feature 252 configured as one or more corresponding cylindrical receptacles. In some embodiments the mating alignment feature can be integral with one of the cassette plates 214, 220. In some other embodiments, the alignment feature can be a separate component (such as a pin, screw, or the like) that is mutually received by openings defined by the outlet cassette plate 220 and the inlet cassette plate 214. The alignment feature 252 and the mating alignment feature 254 can have alternate configurations or additional components similar to the alignment feature and mating alignment feature as described further herein with respect to FIG. 9.

FIG. 9 is a schematic exploded view of some components of an alternate example cassette assembly 310 having an alternative example cassette 312 consistent with the technology disclosed herein. The cassette 312 has an inlet cassette plate 314 and an outlet cassette plate 320. It will be understood the components referenced in the description of FIG. 9 herein are consistent with the descriptions of the same components described elsewhere herein unless contradictory to the current description or corresponding figures.

The outlet cassette plate 320 can include an alignment feature 352. The inlet cassette plate 314 can include a mating alignment feature 354 that is configured to mate with the alignment feature 352 when the cassette plates 314, 320 are properly aligned and stacked. The alignment feature 352 is configured to be laterally aligned with the mating alignment feature 354. The alignment feature 352 and the mating alignment feature 354 can assist in operatively coupling the outlet cassette plate 320 and the inlet cassette plate 314. The alignment feature 352 and the mating alignment feature 354 can advantageously guide a user to correctly stack the various cassette plates to assemble the cassette. In some embodiments, the alignment feature 352 may include a protrusion and the mating alignment feature may include a receptacle that is configured to receive the protrusion, although the reverse configuration is also contemplated. In some alternative embodiments, the alignment feature 352 may form a snap-fit with the mating alignment feature 354. In other alternative embodiments, the alignment feature 352 may include a visual indicator such as a marking that is configured to align with the mating alignment feature 354, and vice versa. FIG. 9 will be described in more detail below with respect to cassette assembly configurations.

### Cassette Assemblies

One or more cassettes 112 can be arranged in a stacked configuration to form a cassette assembly 110 consistent with the technology disclosed herein, an example of which is depicted in FIGS. 1-4. The cassette assembly 110 has one or more cassettes 112, where each of the cassettes 112 are consistent with the discussions above. In the stacked configuration, each inlet cassette inlet flow path 116 of each inlet cassette plate 114 laterally aligns with each outlet cassette inlet flow path 122 of each outlet cassette plate 120. Each inlet cassette inlet flow path 116 is sealably coupled to at least one outlet cassette inlet flow path 122. Similarly, in the stacked configuration, each inlet cassette outlet flow path 124 laterally aligns with each outlet cassette outlet flow path 118. The inlet flow paths 116, 122 of each of the cassettes 112 cumulatively define a substantial portion of the fluid inlet flow path 122a of the cassette assembly 110. Similarly, the outlet flow paths 118, 124 cumulatively define a substantial portion of the fluid outlet flow path 124a of the cassette assembly 110.

The cassette assembly 110 has a first cassette plate 190 and a last cassette plate 192 (FIGS. 1, 3B, and 3C). The first cassette plate 190 is the outer most inlet cassette plate 114 in the stack of cassettes. The last cassette plate 192 is the outer most outlet cassette plate 120 in the stack of cassettes. In embodiments where the cassette assembly 110 has a single cassette 112, the first cassette plate 190 is the inlet cassette plate 114 and the last cassette plate 192 is the outlet cassette plate 120. Notably, the inlet cassette outlet flow path 124 of the first cassette plate 190, which can be referred to as the first inlet cassette outlet flow path 191 (FIG. 3C) defines an inactive volume of the fluid outlet flow path 124a. Particularly, fluid flow is directed from the separation layer of each of the cassettes 112 to the assembly outlet 110b via the fluid outlet flow path 124a, and the first inlet cassette outlet flow path 191 is not positioned to receive such fluid flow (such as from a preceding cassette in the stack). Similarly, the outlet cassette inlet flow path 122 of the last cassette plate 192, which can be referred to as the last outlet cassette inlet flow path 193 (FIG. 3B), defines an inactive volume of the fluid inlet flow path 122a because the last outlet cassette inlet flow path 193 is not positioned to direct fluid to a subsequent cassette. Such inactive volumes of the first inlet cassette outlet flow path 191 and the last outlet cassette inlet flow path 193 may negatively impact filtration operations such as introducing unpredictability in fluid flow or collecting fluid that can become stagnant.

In various embodiments the cassette assembly 110 has an inlet plug 126 and an outlet plug 128. The inlet plug 126 can be configured to be inserted in the last outlet cassette inlet flow path 193 to seal the last outlet cassette inlet flow path 193 (as illustrated in FIG. 3B), such that fluid flow into the cassette assembly 110 inlet is directed through the cassettes 112. The inlet plug 126 can be configured to be removable and reinsertable in the last outlet cassette inlet flow path 193. The outlet plug 128 can be configured to be inserted in the first inlet cassette outlet flow path 191 to seal the first inlet cassette outlet flow path 191, such that fluid flow from the cassettes is directed to the assembly outlet 110b. The outlet plug 128 can be configured to be removable and reinsertable in the first inlet cassette outlet flow path 191.

The inlet plug 126 may be inserted by pushing it into the last outlet cassette inlet flow path 193. Similarly, the outlet plug 128 may be inserted by pushing it into the first inlet cassette outlet flow path 191. Each plug 126, 128 may be constructed of a variety of different materials and combinations of materials. In some embodiments, the plugs 126, 128 are a plastic component. In other embodiments, one or both plugs 126, 128 are constructed of metal. In one example, the plugs 126, 128 are injection-molded, 3D printed or other material. The plugs 126, 128 can be constructed of, for example, a rubber, silicone, polyurethane, or other elastomeric material. In some embodiments the inlet plug 126 and the outlet plug 128 are constructed of the same material; in other embodiments the inlet plug 126 and the outlet plug 128 are constructed of different materials. The plugs 126, 128 are configured to frictionally engage the corresponding cassette plate 190, 192 that receives the plug. In some embodiments, the plugs sealably engage the corresponding cassette plate 190, 192 that receives the plug 126, 128. The plugs 126, 128 can be removable either by pulling them out of their respective paths 122, 118, or by pushing the plugs forward through the paths until them are pushed through their respective cassette plates 114, 120 and exit their respective flow paths 122, 118 from the opposite end from where they were inserted.

The inlet plug 126 and the outlet plug 128 can be configured as a solid cylindrical plug, in some embodiments. In other embodiments a plug 126, 128 can be threaded similar to the port plugs discussed above. In the latter example, the plugs 126, 128 can be removed and reinserted by twisting the plug 126, 128 relative to the cassette it is installed in. In alternative embodiments, the plugs 126, 128 can be configured as a snap-fit plug into their respective paths 122, 118, or can further alternatively be configured as a curable liquid which solidifies inside their respective paths 122, 118.

The plugs 126, 128 may each advantageously fill a corresponding inactive volume within the fluidically coupled pathways and cassettes. Such a configuration may advantageously prevent entry of fluid into the inactive volume during filtration operations, which may improve filtration performance and maximize the volume of filtered fluid. Further, in some embodiments, one or both of the plugs 126, 128 are completely received by their respective paths 122, 118 such that they do not extend outwardly from the cassette 112. Such a configuration may advantageously allow a relatively compact profile of the cassette assembly 110, and may also advantageously negate the need, for example, for an external device to close or plug the paths 122, 118.

The cassette assembly 110 can further include a first end plate 160 and a second end plate 162, as illustrated in FIGS. 1-3C. The first end plate 160 can be operatively couplable to an inlet cassette plate 114. Generally, the first end plate 160 is coupled to the first cassette plate 190 of the cassette assembly 110. The second end plate 162 can be operatively couplable to an outlet cassette plate 120 of a cassette 112. Generally, the second end plate 162 is coupled to the last cassette plate 192 of the cassette assembly 110. The end plates 160, 162 may advantageously provide rigidity and structure to the overall assembly 110 and may also advantageously provide a higher resistance to internal pressures resulting from fluid filtration.

The first end plate 160 can include a first inlet port 164 (FIGS. 3A-3B). The first inlet port 164 can be configured to extend to the inlet cassette inlet flow path 116 of the first cassette plate 190. The first inlet port 164 is generally configured for fluid communication with the first inlet cassette inlet flow path 116. More particularly, the first inlet port 164 defines a fluid flow pathway that is configured to extend from an assembly inlet 110a to the first inlet cassette inlet flow path 116. The second end plate 162 can include the second outlet port 170. The second outlet port 170 is generally configured for fluid communication with the last outlet cassette outlet flow path 118. The second outlet port 170 can be configured to extend from the last outlet cassette outlet flow path 118 to an assembly outlet 110b. More particularly, the second outlet port 170 defines a fluid flow pathway through which fluid exits from the last outlet cassette outlet flow path 118 of the assembly 110 through the assembly outlet 110b.

A syringe, tube, or other implement can be used to introduce fluid to the cassette assembly 110. Such implements may include mating components such as, for example, a luer lock, that is configured to sealably engage one or both of the first inlet port 164 and the second outlet port 170. In alternative embodiments, the first inlet port 164 and the second outlet port 170 can be configured to mate with, for example, tubing of various sizes, syringes or needles, etc. In further alternative embodiments, the first inlet port 164 and the second outlet port 170 can be configured to be closeable or sealable and can be further configured to be reopened or unsealed.

The cassette assembly 110 can further include a fastener 172 (FIG. 1). The fastener 172 is generally configured to retain the components of the cassette assembly 110 in an operative configuration. The fastener 172 can be configured to operatively couple the inlet cassette plate 114 and the outlet cassette plate 120. In embodiments with more than one cassette 112, the fastener 172 can operatively couple each of the cassette plates. In the current example, the fastener 172 includes a bolt 174. In some embodiments, the inlet cassette plate 114 can define a first axial through-hole (not currently visible). The outlet cassette plate 120 can define a second axial through-hole (not currently visible). The first axial through-hole and the second axial through-hole can be configured to laterally align with one another to receive the bolt 174. There may be more than one bolt 174, and respectively there may be more than one aligned through-hole to receive the more than one bolt 174.

In embodiments with the first end plate 160 and/or the second end plate 162, the fastener 172 can be configured to operatively couple the first end plate 160, the inlet cassette plate 114, the outlet cassette plate 120, and the second end plate 162. The first end plate 160 can define a third axial through-hole 180, and the second end plate 162 can define a fourth axial through-hole 182 (as illustrated in FIG. 1). Each of the first, second, third, and fourth axial through-holes can be configured to be laterally aligned with one another to receive the bolt 174. In some embodiments, at least one of the first, second, third, and fourth axial through-holes may include a threaded hole that is configured to engage the bolt 174.

In the examples consistent with the embodiment depicted in FIGS. 1-3C, the fasteners 172 are configured to engage the first end plate 160 and the second end plate 162. Such fasteners 172 do not directly engage any of the cassettes in the current example. The cassettes 112 are compressibly received by the end plates 160, 162. In particular, upon engagement of the fasteners 172, the end plates 160, 162 are configured to exert a compression force in the axial direction on the cassettes 112, which results in a relatively secured stack of cassettes 112.

In the particular example of FIGS. 1-3C, the cassette assembly 110 has fasteners 172 that include a plurality of bolts, where each bolt has a first nut 184 and a second nut 186. The first nut 184 can be configured to receive a first end of the bolt 174. The second nut 186 can be configured to receive an opposite, second end of the bolt 174. The first and second nuts 184, 186 can be configured to apply a compression force to the cassette assembly 110. The nuts 184, 186 can specifically apply the compression force to the operatively coupled end plates 160, 162 via the bolt 174. The first nut 184 can be in contact with the first end plate 160, and the second nut 186 can be in contact with the second end plate 162, or vice versa. Thus, the nuts 184, 186 can apply the compression force to the first and second end plates 160, 162. As a result, the end plates 160, 162 exert compression force on the stack of cassettes, which may advantageously seal each of the fluid flow path(s) through the cassette 112. In alternative embodiments, the fastener 172 may include various clamps, bolts, snap-fits, ties, etc., that can apply the compression force as described herein.

In further alternative embodiments, the fastener 172 may include at least one threaded bolt which threadably engages with the at least one threaded hole defined by at least one of the inlet cassette plate 114, the outlet cassette plate 120, the first end plate 160, and the second end plate 162. In embodiments with the at least one threaded bolt engaged with the at least one threaded hole, at least one of the first and second nuts 184, 186 may not be necessary. The at least one of the first and second nuts 184, 186 may not be necessary because of the threaded engagement between the threaded bolt and the threaded hole.

Returning again to FIG. 9, the inlet cassette plate 314 can define a first axial through-hole 376. The outlet cassette plate 320 can define a second axial through-hole 378. The first axial through-hole 376 and the second axial through-hole 378 can be configured to laterally align with one another to receive a fastener such as a pin, screw, bolt (not shown). There may be more than one fastener, and respectively there may be more than one pair of laterally aligned through-holes, which each are configured to receive a fastener. In embodiments with the first end plate 360 and/or the second end plate 362, the fastener can be configured to operatively couple the first end plate 360, the inlet cassette plate 314, the outlet cassette plate 320, and the second end plate 362. The first end plate 360 can define a third axial through-hole 380, and the second end plate 362 can define a fourth axial through-hole 382. Each of the first, second, third, and fourth axial through-holes can be configured to be laterally aligned with one another to receive the fastener.

### Exemplary Aspects

Aspect 1. A cassette assembly comprising:
an inlet cassette plate defining an inlet cassette inlet flow path and an inlet cassette outlet flow path, wherein the inlet cassette inlet flow path and the inlet cassette outlet flow path extend axially through the inlet cassette plate;
an outlet cassette plate configured to be arranged in a stack with the inlet cassette plate, the outlet cassette plate defining an outlet cassette inlet flow path and an outlet cassette outlet flow path, wherein the outlet cassette inlet flow path and the outlet cassette outlet flow path extend axially through the outlet cassette plate, the inlet cassette inlet flow path is configured to be laterally aligned with the outlet cassette inlet flow path, and the inlet cassette outlet flow path is configured to be laterally aligned with the outlet cassette outlet flow path;
an inlet plug configured to be inserted in the outlet cassette inlet flow path to seal the outlet cassette inlet flow path, wherein the inlet plug is configured to be removable and reinsertable in the outlet cassette inlet flow path;
an outlet plug configured to be inserted in the inlet cassette outlet flow path to seal the inlet cassette outlet flow path, wherein the outlet plug is configured to be removable and reinsertable in the inlet cassette outlet flow path; and
a separation layer disposed between the inlet cassette plate and the outlet cassette plate, wherein the inlet cassette inlet flow path is configured to be in fluid communication with the outlet cassette outlet flow path through the separation layer to form an assembly flow path.

Aspect 2. The cassette assembly of any one of Aspects 1 and 3-22, wherein the inlet cassette plate, the outlet cassette plate, the inlet plug, the outlet plug, and the separation layer define a single cassette.

Aspect 3. The cassette assembly of any one of Aspects 1-2 and 4-22, wherein the inlet cassette plate, the outlet cassette plate, the inlet plug, the outlet plug, and the separation layer define more than one cassette.

Aspect 4. The cassette assembly of any one of Aspects 1-3 and 5-22, further comprising:
an inlet channel extending along an effective inlet surface area of the separation layer in fluid communication with the inlet cassette inlet flow path; and
an outlet channel extending along an effective outlet surface area of the separation layer towards the outlet cassette outlet flow path.

Aspect 5. The cassette assembly of any one of Aspects 1-4 and 6-22, further comprising:
an inlet flow path extension defined by the inlet cassette plate configured to fluidically couple the inlet cassette inlet flow path and the inlet channel; and
an outlet flow path extension defined by the outlet cassette plate configured to fluidically couple the outlet cassette outlet flow path and the outlet channel.

Aspect 6. The cassette assembly of any one of Aspects 1-5 and 7-22, wherein the inlet flow path extension comprises:
an inlet extension first portion extending laterally from the inlet cassette inlet flow path towards the inlet channel; and
an inlet extension second portion extending laterally along a width of the effective inlet surface area.

Aspect 7. The cassette assembly of any one of Aspects 1-6 and 8-22, wherein the outlet flow path extension comprises:
an outlet extension first portion extending laterally from the outlet cassette outlet flow path towards the outlet channel; and
an outlet extension second portion extending laterally along a width of the effective outlet surface area.

Aspect 8. The cassette assembly of any one of Aspects 1-7 and 9-22, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

Aspect 9. The cassette assembly of any one of Aspects 1-8 and 10-22, wherein the separation layer seal comprises an overmolded gasket.

Aspect 10. The cassette assembly of any one of Aspects 1-9 and 11-22, wherein:
the inlet cassette plate defines a first port in selective fluid communication with the inlet cassette inlet flow path, wherein the first port laterally extends through an axial surface of the inlet cassette plate, and
wherein the outlet cassette plate defines a second port in selective fluid communication with the outlet cassette outlet flow path, wherein the second port laterally extends through an axial surface of the outlet cassette plate, and
wherein the cassette assembly further comprises a first port plug configured to seal the first port, wherein the first port plug is removable and reinsertable in the first port, and
wherein the cassette assembly further comprises a second port plug configured to seal the second port, wherein the second port plug is removable and reinsertable in the second port.

Aspect 11. The cassette assembly of any one of Aspects 1-10 and 12-22, wherein the separation layer comprises a membrane stack further comprising a plurality of membrane layers, and wherein the plurality of membrane layers comprises at least 10 membrane layers.

Aspect 12. The cassette assembly of any one of Aspects 1-11 and 13-22, wherein the separation layer has an effective inlet surface area defined by an effective length and an effective width, and wherein the effective length is at least 2.5 times the effective width.

Aspect 13. The cassette assembly of any one of Aspects 1-12 and 14-22, further comprising:
an outlet channel spacer positioned in the outlet channel, wherein the outlet channel spacer is configured to accommodate fluid flow.

Aspect 14. The cassette assembly of any one of Aspects 1-13 and 15-22, further comprising:
an inlet channel spacer positioned in the inlet channel, wherein the inlet channel spacer is configured to accommodate fluid flow.

Aspect 15. The cassette assembly of any one of Aspects 1-14 and 16-22, wherein at least one of the inlet channel spacer and the outlet channel spacer comprises lateral ridges extending across the separation layer.

Aspect 16. The cassette assembly of any one of Aspects 1-15 and 17-22, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

Aspect 17. The cassette assembly of any one of Aspects 1-16 and 18-22, further comprising:
a first end plate operatively couplable to the inlet cassette plate; and
a second end plate operatively couplable to the outlet cassette plate,
wherein the first end plate comprises a first inlet port configured to extend to the inlet cassette inlet flow path, and
wherein the second end plate comprises a second outlet port configured for fluid communication with the outlet cassette outlet flow path.

Aspect 18. The cassette assembly of any one of Aspects 1-17 and 19-22, further comprising a fastener configured to operatively couple the inlet cassette plate and the outlet cassette plate.

Aspect 19. The cassette assembly of any one of Aspects 1-18 and 20-22, further comprising a fastener configured to operatively couple the first end plate, the inlet cassette plate, the outlet cassette plate, and the second end plate.

Aspect 20. The cassette assembly of any one of Aspects 1-19 and 21-22, wherein the fastener comprises a bolt, and
wherein the inlet cassette plate defines a first axial through-hole, and the outlet cassette plate defines a second axial through-hole, wherein the first axial through-hole and the second axial through-hole are configured to laterally align to receive the bolt, and
wherein the cassette assembly further comprises a first nut configured to receive one end of the bolt and a second nut configured to receive an opposite end of the bolt, and wherein the first and second nuts are configured to apply a compression force to the cassette assembly.

Aspect 21. The cassette assembly of any one of Aspects 1-20 and 22, wherein the first end plate defines a third axial through-hole and the second end plate defines a fourth axial through-hole, and wherein each of the first, second, third, and fourth axial through-holes are configured to be laterally aligned to receive the bolt.

Aspect 22. The cassette assembly of any one of Aspects 1-21, further comprising an attachment seal between the inlet cassette plate and the outlet cassette plate, wherein the attachment seal extends laterally around and outside of a periphery of the separation layer.

It should be noted that, as used in this specification and the appended claims, the phrase “configured” describes a system, apparatus, or other structure that is constructed to perform a particular task or adopt a particular configuration. The word “configured” can be used interchangeably with similar words such as “arranged,” “constructed,” “manufactured,” and the like.

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure. These terms are used only to simplify the description, however, and not to limit the interpretation of any embodiment described.

Further, it is understood that the description of any particular element as being connected to or coupled to another element can be directly connected or coupled, or indirectly coupled/connected via intervening elements.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

The foregoing description of the example embodiments has been presented for the purposes of illustration and description. It is not intended to be exhaustive or to limit the embodiments to the precise form disclosed. Modifications and variations are possible in light of the above teaching. Any or all features of the disclosed embodiments can be applied individually or in any combination and are not meant to be limiting, but purely illustrative. It is to be understood that the above description is intended to be illustrative, and not restrictive, and the claims are not limited to the illustrative embodiments as set forth herein.

What is claimed is:

1. A cassette assembly comprising:
an inlet cassette plate defining an inlet cassette inlet flow path and an inlet cassette outlet flow path, wherein the inlet cassette inlet flow path and the inlet cassette outlet flow path extend axially through the inlet cassette plate;
an outlet cassette plate configured to be arranged in a stack with the inlet cassette plate, the outlet cassette plate defining an outlet cassette inlet flow path and an outlet cassette outlet flow path, wherein the outlet cassette inlet flow path and the outlet cassette outlet flow path extend axially through the outlet cassette plate, the inlet cassette inlet flow path is configured to be laterally aligned with the outlet cassette inlet flow path, and the inlet cassette outlet flow path is configured to be laterally aligned with the outlet cassette outlet flow path;
an inlet plug configured to be inserted in the outlet cassette inlet flow path to seal the outlet cassette inlet flow path, wherein the inlet plug is configured to be removable and reinsertable in the outlet cassette inlet flow path;
an outlet plug configured to be inserted in the inlet cassette outlet flow path to seal the inlet cassette outlet flow path, wherein the outlet plug is configured to be removable and reinsertable in the inlet cassette outlet flow path; and
a separation layer disposed between the inlet cassette plate and the outlet cassette plate, wherein the inlet cassette inlet flow path is configured to be in fluid communication with the outlet cassette outlet flow path through the separation layer to form an assembly flow path.

2. The cassette assembly of claim 1, wherein the inlet cassette plate, the outlet cassette plate, the inlet plug, the outlet plug, and the separation layer define a single cassette.

3. The cassette assembly of claim 1, wherein the inlet cassette plate, the outlet cassette plate, the inlet plug, the outlet plug, and the separation layer define more than one cassette.

4. The cassette assembly of claim 1, further comprising:
an inlet channel extending along an effective inlet surface area of the separation layer in fluid communication with the inlet cassette inlet flow path; and
an outlet channel extending along an effective outlet surface area of the separation layer towards the outlet cassette outlet flow path.

5. The cassette assembly of claim 4, further comprising:
an inlet flow path extension defined by the inlet cassette plate configured to fluidically couple the inlet cassette inlet flow path and the inlet channel; and
an outlet flow path extension defined by the outlet cassette plate configured to fluidically couple the outlet cassette outlet flow path and the outlet channel.

6. The cassette assembly of claim 5, wherein the inlet flow path extension comprises:
an inlet extension first portion extending laterally from the inlet cassette inlet flow path towards the inlet channel; and
an inlet extension second portion extending laterally along a width of the effective inlet surface area.

7. The cassette assembly of claim 5, wherein the outlet flow path extension comprises:
an outlet extension first portion extending laterally from the outlet cassette outlet flow path towards the outlet channel; and
an outlet extension second portion extending laterally along a width of the effective outlet surface area.

8. The cassette assembly of claim 4, further comprising a separation layer seal installed between the inlet cassette plate and the outlet cassette plate, wherein the separation layer seal is in contact with the inlet cassette plate and the outlet cassette plate, and wherein the separation layer seal is configured to fluidically seal a perimeter region of the separation layer, a perimeter region of the inlet channel, and a perimeter region of the outlet channel.

9. The cassette assembly of claim 8, wherein the separation layer seal comprises an overmolded gasket.

10. The cassette assembly of claim 1, wherein:
the inlet cassette plate defines a first port in selective fluid communication with the inlet cassette inlet flow path, wherein the first port laterally extends through an axial surface of the inlet cassette plate, and
wherein the outlet cassette plate defines a second port in selective fluid communication with the outlet cassette outlet flow path, wherein the second port laterally extends through an axial surface of the outlet cassette plate, and
wherein the cassette assembly further comprises a first port plug configured to seal the first port, wherein the first port plug is removable and reinsertable in the first port, and
wherein the cassette assembly further comprises a second port plug configured to seal the second port, wherein the second port plug is removable and reinsertable in the second port.

11. The cassette assembly of claim 1, wherein the separation layer comprises a membrane stack further comprising a plurality of membrane layers, and wherein the plurality of membrane layers comprises at least 10 membrane layers.

12. The cassette assembly of claim 1,
wherein the separation layer has an effective inlet surface area defined by an effective length and an effective width, and wherein the effective length is at least 2.5 times the effective width.

13. The cassette assembly of claim 1, further comprising:
an outlet channel spacer positioned in the outlet channel, wherein the outlet channel spacer is configured to accommodate fluid flow.

14. The cassette assembly of claim 1, further comprising:
an inlet channel spacer positioned in the inlet channel, wherein the inlet channel spacer is configured to accommodate fluid flow.

15. The cassette assembly of claim 14, wherein the inlet channel spacer comprises lateral ridges extending across the separation layer.

16. The cassette assembly of claim 1, wherein the outlet cassette plate comprises an alignment feature and the inlet cassette plate comprises a mating alignment feature, and wherein the alignment feature is laterally aligned with the mating alignment feature to operatively couple the outlet cassette plate and the inlet cassette plate.

17. The cassette assembly of claim 1, further comprising:
a first end plate operatively couplable to the inlet cassette plate; and
a second end plate operatively couplable to the outlet cassette plate,
wherein the first end plate comprises a first inlet port configured to extend to the inlet cassette inlet flow path, and
wherein the second end plate comprises a second outlet port configured for fluid communication with the outlet cassette outlet flow path.

18. The cassette assembly of claim 1, further comprising a fastener configured to operatively couple the inlet cassette plate and the outlet cassette plate.

19. The cassette assembly of claim 18, wherein the fastener comprises a bolt, and
wherein the inlet cassette plate defines a first axial through-hole, and the outlet cassette plate defines a second axial through-hole, wherein the first axial through-hole and the second axial through-hole are configured to laterally align to receive the bolt, and
wherein the cassette assembly further comprises a first nut configured to receive one end of the bolt and a second nut configured to receive an opposite end of the bolt, and wherein the first and second nuts are configured to apply a compression force to the cassette assembly.

20. The cassette assembly of claim 1, further comprising an attachment seal between the inlet cassette plate and the outlet cassette plate, wherein the attachment seal extends laterally around and outside of a periphery of the separation layer.
